(19) United States
(12) Patent Application Publication
(10) Pub. No.: US 2023/0362819 A1
(43) Pub. Date: Nov. 9, 2023

(54) POWER CONTROL FOR BURST COMMUNICATIONS

(71) Applicant: QUALCOMM Incorporated, San Diego, CA (US)

(72) Inventors: Diana MAAMARI, San Diego, CA (US); Prashanth Haridas HANDE, San Diego, CA (US); Mickael MONDET, Louannec (FR); Yih-Hao LIN, San Diego, CA (US); Peerapol TINNAKORNSRISUPHAP, San Diego, CA (US); Hyun Yong LEE, San Diego, CA (US); Dario Serafino TONESI, San Diego, CA (US)

(21) Appl. No.: 18/304,740

(22) Filed: Apr. 21, 2023

Related U.S. Application Data
(60) Provisional application No. 63/364,162, filed on May 4, 2022.

(51) Int. Cl. H04W 52/02; H04W 76/20

(52) U.S. Cl. CPC H04W 52/0235; H04W 76/20

(57) ABSTRACT

Various aspects of the present disclosure generally relate to wireless communication. In some aspects, a user equipment (UE) may receive a burst transmission including one or more packets. The UE may transition from a first communication state to a second communication state based at least in part on receiving a power control indication triggered by an end of burst indication associated with burst metadata accompanying the burst transmission, wherein a power of the second communication state is different from a power of the first communication state. Numerous other aspects are described.

### CROSS-REFERENCE TO RELATED APPLICATION

This patent application claims priority to U.S. Provisional Patent Application No. 63/364,162, filed on May 4, 2022, entitled “POWER CONTROL FOR BURST COMMUNICATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for power control for burst communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In burst communications, such as for extended reality (XR) traffic or augmented reality (AR) traffic, application data units (ADUs) may be grouped into burst transmissions. For example, a single burst transmission may correspond to a video frame and an ADU may correspond to a slice of the video frame. Similarly, packet data units (PDUs) can be grouped into PDU sets that are transmitted in burst transmissions. A user equipment (UE) may transition from a first communication state to a second communication state with a power that is different from a power of the first communication state to reduce a utilization of power resources. For example, the UE may transition from a discontinuous reception (DRX) on duration or active mode to a DRX off duration or sleep/inactive mode.

In order to switch between communication states, a network entity and/or a UE may use a timer to determine whether to remain in a particular state or transition to a different state. For example, in DRX communications, a UE may transition from a DRX on duration to a DRX off duration after expiration of an inactivity timer. However, in some cases, the UE may waste power resources while waiting for a timer, such as an inactivity timer, to expire. A length of the timer can be reduced to save power (e.g., by allowing the UE to enter the lower power state faster), but this can result in the UE prematurely entering the lower power state (e.g., when a network entity had further control information or data to transmit to the UE).

Some aspects described herein use burst metadata to provide burst awareness. For example, a first network entity (e.g., a base station) may receive, from a second network entity (e.g., a core network entity, such as an application server (AS) or a user plane function (UPF), among other examples) an end of burst indication associated with burst metadata accompanying a burst transmission of one or more packets. In this case, the first network entity may determine when the burst transmission is to end and may transmit a power control indication to trigger a transition from a first communication state (e.g., a DRX on duration) to a second communication state (e.g., a DRX off duration). Based at least in part on receiving the power control indication, a UE may transition from the first communication state to the second communication state. In this way, the UE avoids remaining in the first communication state for an excessive period of time, thereby saving power resources. Moreover, by transitioning based at least in part on receiving a power control indication, the UE avoids prematurely transitioning to the power saving state, thereby avoiding dropped communications during the DRX off duration or excessive latency associated with communications being delayed until a next DRX on duration.

Some aspects described herein relate to a method of wireless communication performed by a UE. The method may include receiving a burst transmission including one or more packets. The method may include transitioning from a first communication state to a second communication state based at least in part on receiving a power control indication triggered by an end of burst indication associated with burst metadata accompanying the burst transmission, wherein a power of the second communication state is different from a power of the first communication state.

Some aspects described herein relate to a method of wireless communication performed by a network entity. The method may include receiving an end of burst indication, associated with burst metadata accompanying a burst transmission of one or more packets, identifying an end of the burst transmission of one or more packets. The method may include transmitting a power control indication, in connection with the burst transmission of the one or more packets, to indicate a transition from a first communication state to a second communication state, wherein a power of the second communication state is different from a power of the first communication state.

Some aspects described herein relate to a UE for wireless communication. The UE may include a memory and one or more processors coupled to the memory. The one or more processors may be configured to receive a burst transmission including one or more packets. The one or more processors may be configured to transition from a first communication state to a second communication state based at least in part on receiving a power control indication triggered by an end of burst indication associated with burst metadata accompanying the burst transmission, wherein a power of the second communication state is different from a power of the first communication state.

Some aspects described herein relate to a network entity for wireless communication. The network entity may include a memory and one or more processors coupled to the memory. The one or more processors may be configured to receive an end of burst indication, associated with burst metadata accompanying a burst transmission of one or more packets, identifying an end of the burst transmission of one or more packets. The one or more processors may be configured to transmit a power control indication, in connection with the burst transmission of the one or more packets, to indicate a transition from a first communication state to a second communication state, wherein a power of the second communication state is different from a power of the first communication state.

Some aspects described herein relate to a non-transitory computer-readable medium that stores a set of instructions for wireless communication by a UE. The set of instructions, when executed by one or more processors of the UE, may cause the UE to receive a burst transmission including one or more packets. The set of instructions, when executed by one or more processors of the UE, may cause the UE to transition from a first communication state to a second communication state based at least in part on receiving a power control indication triggered by an end of burst indication associated with burst metadata accompanying the burst transmission, wherein a power of the second communication state is different from a power of the first communication state.

Some aspects described herein relate to a non-transitory computer-readable medium that stores a set of instructions for wireless communication by a network entity. The set of instructions, when executed by one or more processors of the network entity, may cause the network entity to receive an end of burst indication, associated with burst metadata accompanying a burst transmission of one or more packets, identifying an end of the burst transmission of one or more packets. The set of instructions, when executed by one or more processors of the network entity, may cause the network entity to transmit a power control indication, in connection with the burst transmission of the one or more packets, to indicate a transition from a first communication state to a second communication state, wherein a power of the second communication state is different from a power of the first communication state.

Some aspects described herein relate to an apparatus for wireless communication. The apparatus may include means for receiving a burst transmission including one or more packets. The apparatus may include means for transitioning from a first communication state to a second communication state based at least in part on receiving a power control indication triggered by an end of burst indication associated with burst metadata accompanying the burst transmission, wherein a power of the second communication state is different from a power of the first communication state.

Some aspects described herein relate to an apparatus for wireless communication. The apparatus may include means for receiving an end of burst indication, associated with burst metadata accompanying a burst transmission of one or more packets, identifying an end of the burst transmission of one or more packets. The apparatus may include means for transmitting a power control indication, in connection with the burst transmission of the one or more packets, to indicate a transition from a first communication state to a second communication state, wherein a power of the second communication state is different from a power of the first communication state.

Some aspects described herein relate to a network entity for wireless communication. The network entity may include a memory and one or more processors coupled to the memory. The one or more processors may be configured to receive application data for transmission to a UE via another network entity. The one or more processors may be configured to transmit the application data with an end of burst indication, associated with burst metadata accompanying a burst transmission of one or more packets of the application data, identifying an end of the burst transmission of one or more packets.

Some aspects described herein relate to a method of wireless communication performed by a network entity. The method may include receiving application data for transmission to a UE via another network entity. The method may include transmitting the application data with an end of burst indication, associated with burst metadata accompanying a burst transmission of one or more packets of the application data, identifying an end of the burst transmission of one or more packets.

Some aspects described herein relate to a non-transitory computer-readable medium that stores a set of instructions for wireless communication by a network entity. The set of instructions, when executed by one or more processors of the network entity, may cause the network entity to receive application data for transmission to a UE via another network entity. The set of instructions, when executed by one or more processors of the network entity, may cause the network entity to transmit the application data with an end of burst indication, associated with burst metadata accompanying a burst transmission of one or more packets of the application data, identifying an end of the burst transmission of one or more packets.

Some aspects described herein relate to an apparatus for wireless communication. The apparatus may include means for receiving application data for transmission to a UE via another apparatus. The apparatus may include means for transmitting the application data with an end of burst indication, associated with burst metadata accompanying a burst transmission of one or more packets of the application data, identifying an end of the burst transmission of one or more packets.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of physical channels and reference signals in a wireless network, in accordance with the present disclosure.

FIG. 5 is a diagram illustrating an example of a discontinuous reception (DRX) configuration, in accordance with the present disclosure.

FIG. 6 is a diagram illustrating an example of a protocol stack for network entities and a UE, in accordance with the present disclosure.

FIG. 7 is a diagram illustrating an example associated with power control for burst communications, in accordance with the present disclosure.

FIGS. 8-10 are diagrams illustrating example processes associated with power control for burst communications, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

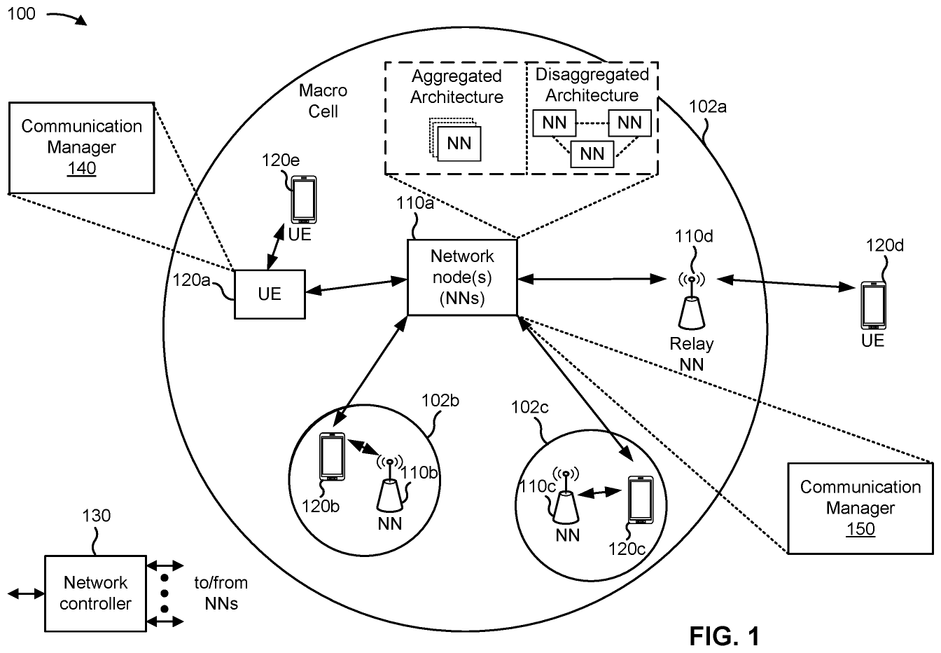

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a burst transmission including one or more packets; and transition from a first communication state to a second communication state based at least in part on receiving a power control indication triggered by an end of burst indication associated with burst metadata accompanying the burst transmission, wherein a power of the second communication state is different from a power of the first communication state. Additionally, or alternatively, the communication manager 140 may perform one or more other operations described herein.

In some aspects, a network entity (e.g., the network node 110 or a core network device) may include a communication manager 150. As described in more detail elsewhere herein, the communication manager 150 may receive an end of burst indication, associated with burst metadata accompanying a burst transmission of one or more packets, identifying an end of the burst transmission of one or more packets; and transmit a power control indication, in connection with the burst transmission of the one or more packets, to indicate a transition from a first communication state to a second communication state, wherein a power of the second communication state is different from a power of the first communication state. Additionally, or alternatively, the communication manager 150 may receive application data for transmission to a UE via another network entity; and may transmit the application data with an end of burst indication, associated with burst metadata accompanying a burst transmission of one or more packets of the application data, identifying an end of the burst transmission of one or more packets. Additionally, or alternatively, the communication manager 150 may perform one or more other operations described herein.

As indicated above, FIG. 1 is provided as an example. Other examples may differ from what is described with regard to FIG. 1.

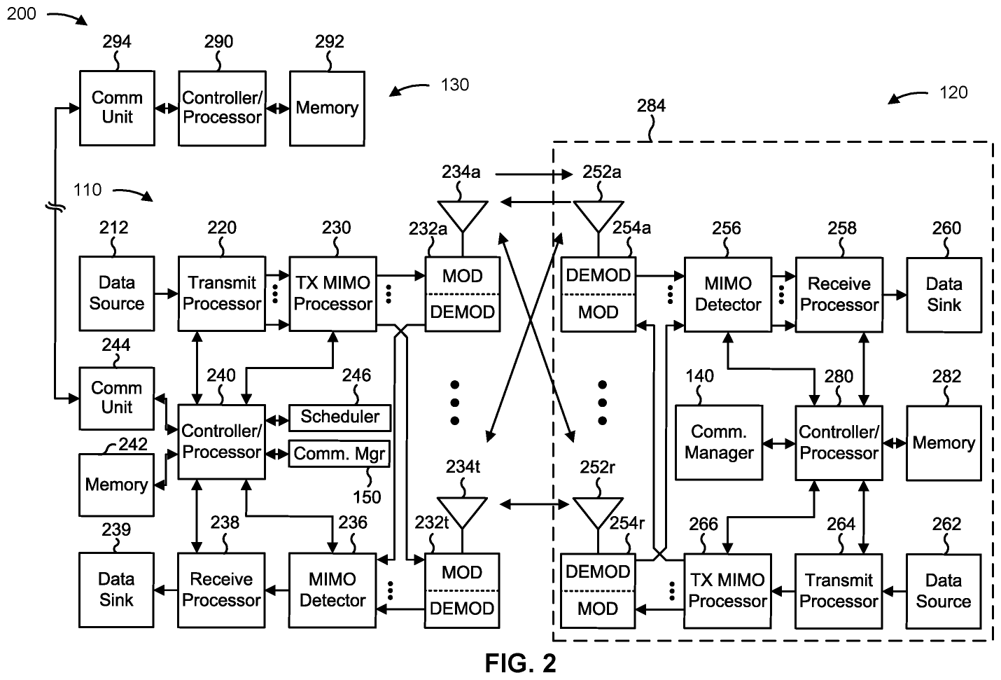

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

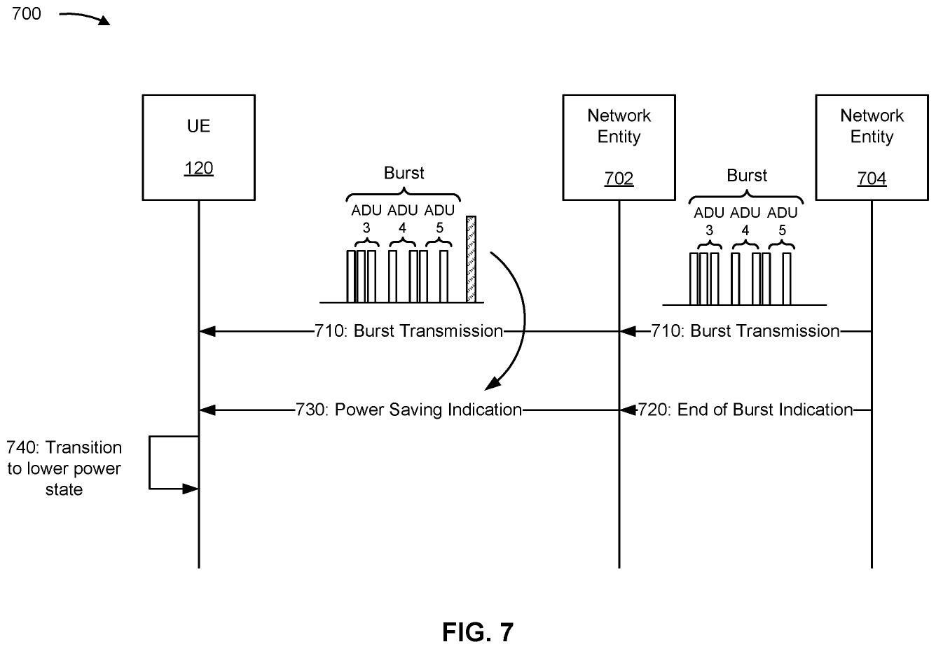

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

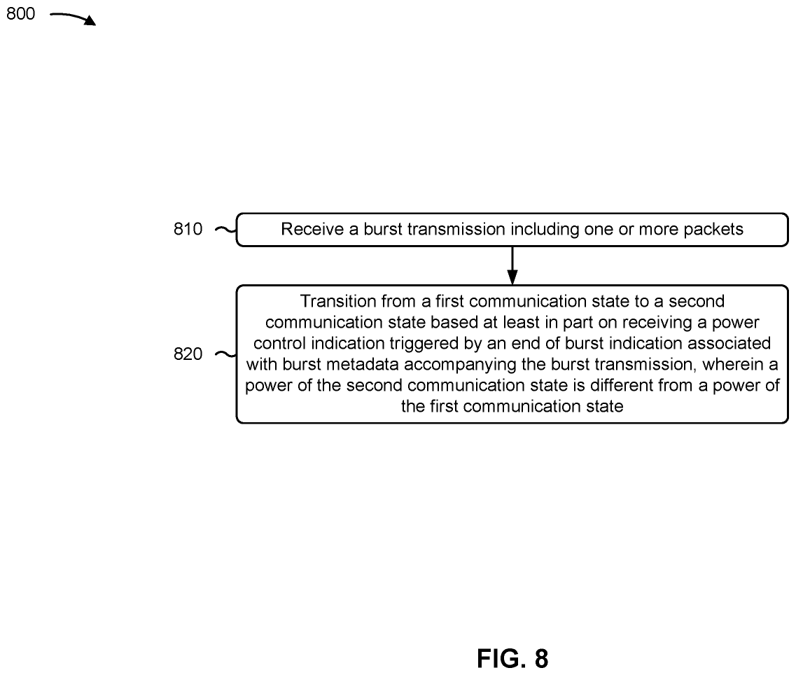

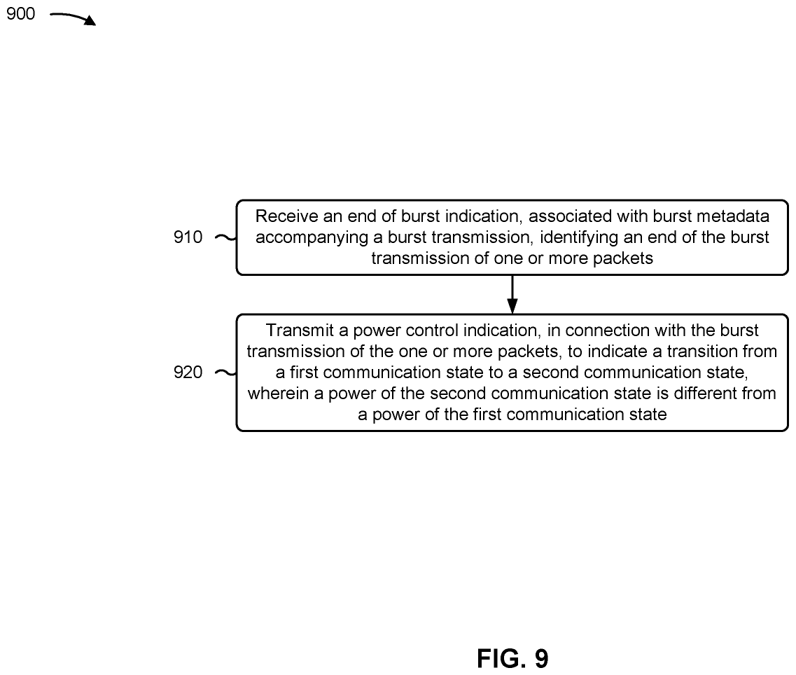

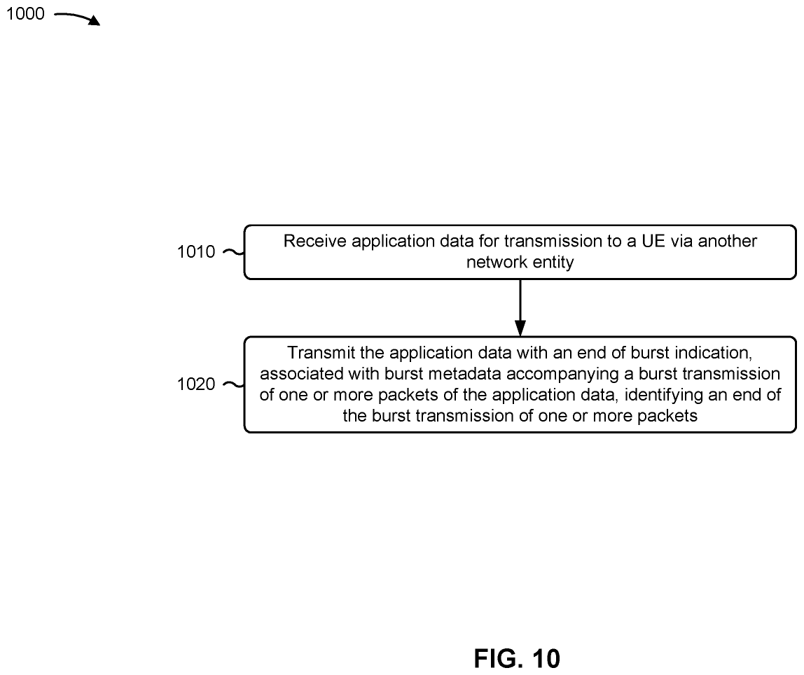

The controller/processor 240 of the network node 110, the controller/processor 280 of the UE 120, and/or any other component(s) of FIG. 2 may perform one or more techniques associated with power control for burst communications, as described in more detail elsewhere herein. In some aspects, the network entity described herein is the network node 110, is included in the network node 110, or includes one or more components of the network node 110 shown in FIG. 2. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a burst transmission including one or more packets; and/or means for transitioning from a first communication state to a second communication state based at least in part on receiving a power control indication triggered by an end of burst indication associated with burst metadata accompanying the burst transmission, wherein a power of the second communication state is different from a power of the first communication state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110 or a core network entity) includes means for receiving an end of burst indication, associated with burst metadata accompanying a burst transmission of one or more packets, identifying an end of the burst transmission of one or more packets; and/or means for transmitting a power control indication, in connection with the burst transmission of the one or more packets, to indicate a transition from a first communication state to a second communication state, wherein a power of the second communication state is different from a power of the first communication state. Additionally, or alternatively, the network entity may receive application data for transmission to a UE via another network entity; and may transmit the application data with an end of burst indication, associated with burst metadata accompanying a burst transmission of one or more packets of the application data, identifying an end of the burst transmission of one or more packets. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

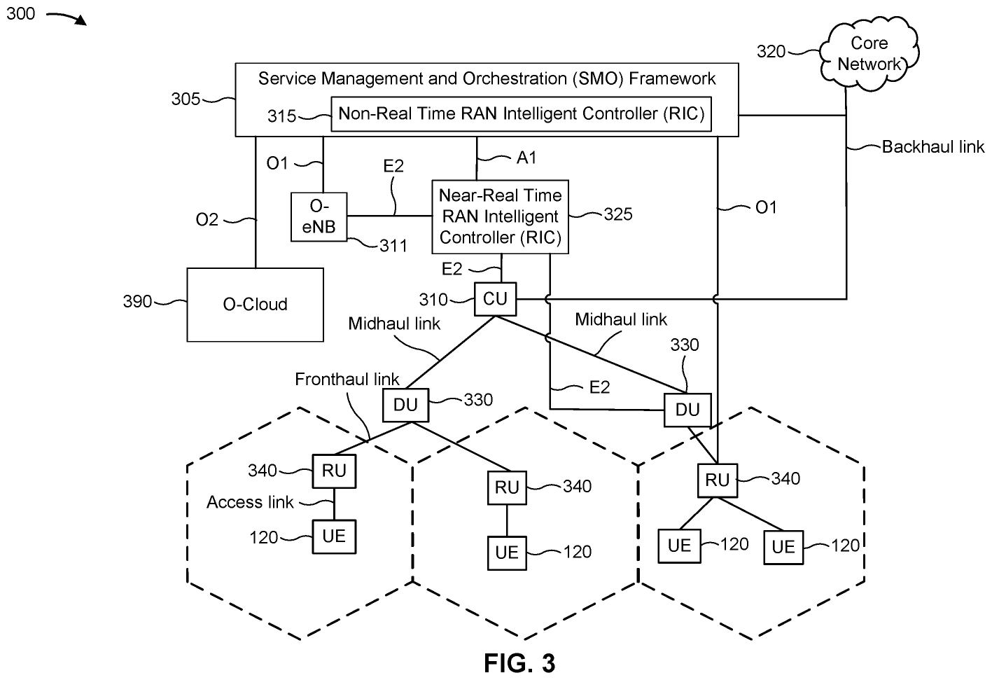

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

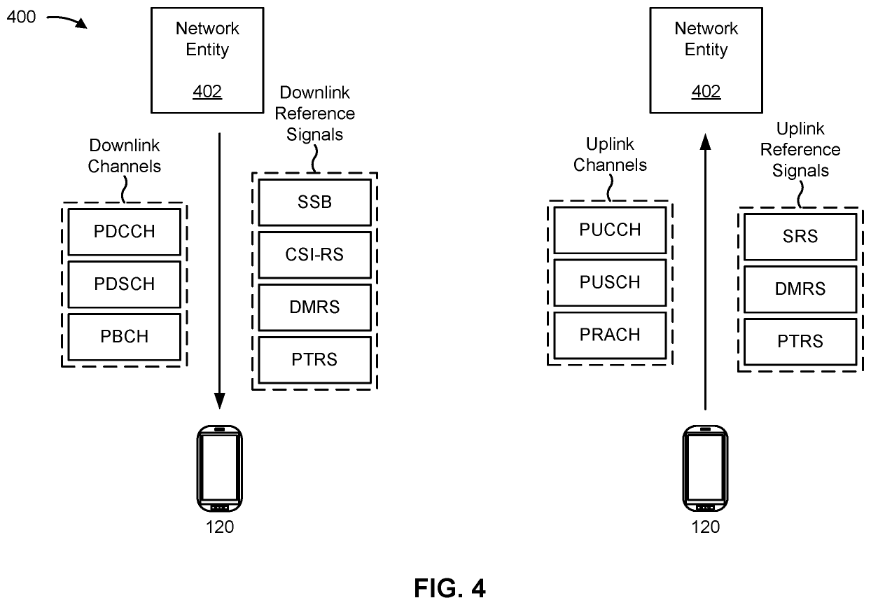

FIG. 4 is a diagram illustrating an example 400 of physical channels and reference signals in a wireless network, in accordance with the present disclosure. As shown in FIG. 4, downlink channels and downlink reference signals may carry information from a network entity 402 to a UE 120, and uplink channels and uplink reference signals may carry information from a UE 120 to a network entity 402.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. The UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. The network entity 402 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network entity 402 may configure a set of CSI-RSs for the UE 120, and the UE 120 may measure the configured set of CSI-RSs. Based at least in part on the measurements, the UE 120 may perform channel estimation and may report channel estimation parameters to the network entity 402 (e.g., in a CSI report), such as a CQI, a precoding matrix indicator (PMI), a CSI-RS resource indicator (CRI), a layer indicator (LI), a rank indicator (RI), or an RSRP, among other examples. The network entity 402 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network entity 402 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. The network entity 402 may then calculate a position of the UE 120 based on the RSTD measurements reported by the UE 120.

An SRS may carry information used for uplink channel estimation, which may be used for scheduling, link adaptation, precoder selection, or beam management, among other examples. The network entity 402 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network entity 402 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

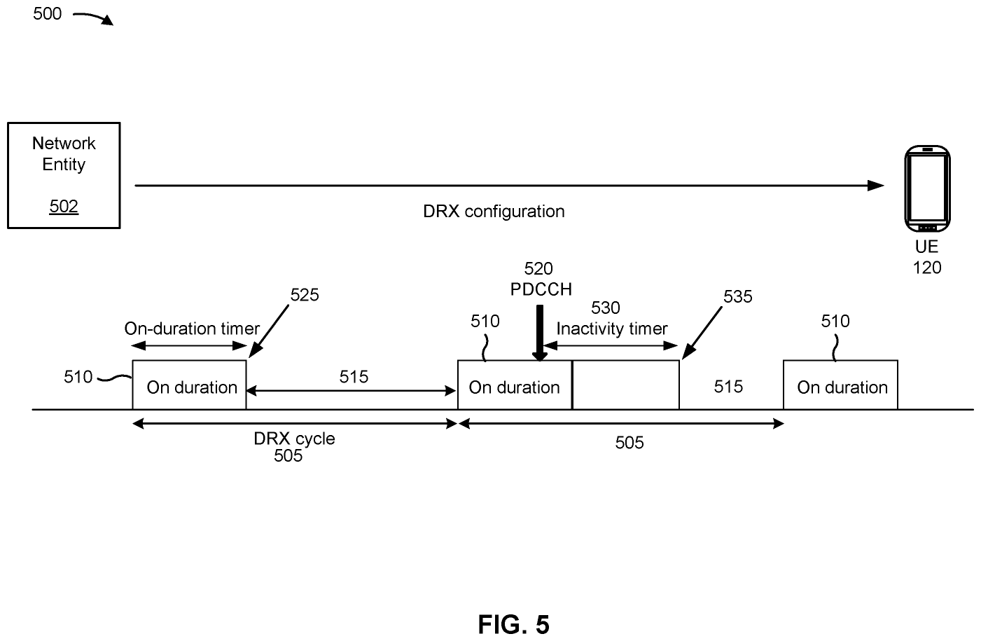

FIG. 5 is a diagram illustrating an example 500 of a discontinuous reception (DRX) configuration, in accordance with the present disclosure.

As shown in FIG. 5, a network entity 502 may transmit a DRX configuration to a UE 120 to configure a DRX cycle 505 for the UE 120. A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a PDCCH during the active time, and may refrain from monitoring the PDCCH during the inactive time.

During the DRX on duration 510 (e.g., the active time), the UE 120 may monitor a downlink control channel (e.g., a PDCCH), as shown by reference number 520. For example, the UE 120 may monitor the PDCCH for DCI pertaining to the UE 120. If the UE 120 does not detect and/or successfully decode any PDCCH communications intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the PDCCH communication is received (e.g., in a transmission time interval (TTI) in which the PDCCH communication is received, such as a slot or a subframe). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state 515.

As indicated above, FIG. 5 is provided as an example. Other examples may differ from what is described with respect to FIG. 5.

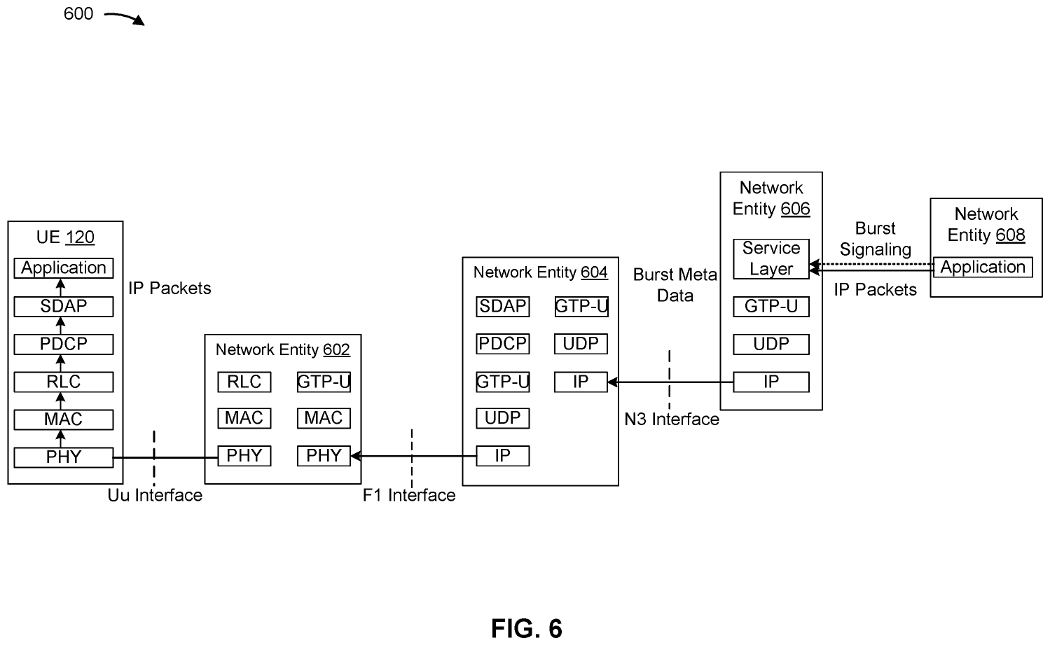

FIG. 6 is a diagram illustrating an example 600 of a protocol stack for network entities 602/604/606/608 and a UE 120, in accordance with the present disclosure. Network entity 602 may correspond to the DU 330 of FIG. 3, network entity 604 may correspond to the CU 310 of FIG. 3, and network entities 606 and 608 may be core network devices associated with the core network 320 of FIG. 3.

The UE 120 and the network entity 602 may include respective PHY layers, MAC layers, and RLC layers. Further, the UE 120 may have a PDCP layer, an SDAP layer, and an application layer. The network entity 602 may have a general packet radio service (GPRS) tunnelling protocol (GTP) user plane (U) (GTP-U) layer that is an endpoint for GTP-U packets. The network entity 602 and the UE 120 may communicate over a Uu interface. The network entity 602 and the network entity 604 may communicate over an F1 interface. The network entity 604 may have an Internet Protocol (IP) layer, a user datagram protocol (UDP) layer, a GTP-U layer, a PDCP layer, and an SDAP layer. A user plane function (e.g., the network entity 606) may handle transport of user data between the UE 120 and the network entity 602.

Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer. The application layer may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network entities 602/604 are transmitting a downlink communication), the SDAP layer may receive a data flow in the form of a quality of service (QoS) flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters.

The SDAP layer may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQs), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network entity 602 is receiving an uplink communication), the operations may be similar to those described for the transmitting side, but reversed. For example, the PHY layer may receive TB s and may provide the TB s on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

The network entity 606 (e.g., a user plane function (UPF)) may have an IP layer, a UDP layer, a GTP-U layer, and a service layer. The network entity 606 may communicate burst metadata toward network entity 604 and/or network entity 602 via an N3 interface. The GTP-U layer of network entity 606 may form the other endpoint of a GTP-U flow with the GTP-U layer of the network entity 602. The UE 120 may have an application layer that receives IP packets from the network entity 608. The network entity 608 may transmit, using burst signaling, IP packets to the network entity 606 for routing to the UE 120.

As indicated above, FIG. 6 is provided as an example. Other examples may differ from what is described with regard to FIG. 6.

In burst communications, such as for extended reality (XR) traffic or augmented reality (AR) traffic, application data units (ADUs) may be grouped into burst transmissions. For example, a single burst transmission may correspond to a video frame and an ADU may correspond to a slice of the video frame. Similarly, PDUs can be grouped into PDU sets that are transmitted in burst transmissions. “Burst transmissions” can refer to data transmissions in which, for example, a set of packets are grouped together within a first threshold period of time, but are separated from other burst transmissions by, for example, a second threshold period of time. Furthermore, burst transmissions may have some commonality, such as shared header information, but may have differences, such as including a different quantity of ADUs in different burst transmissions or a different quantity of packets in different ADUs, among other examples.

As described above, a UE may transition from a first communication state to a second communication state with a power that is different from a power of the first communication state to reduce a utilization of power resources. For example, the UE may transition from a DRX on duration or active mode to a DRX off duration or sleep/inactive mode. In order to switch between communication states, a network entity and/or a UE may use a timer to determine whether to remain in a particular state or transition to a different state. For example, in DRX communications, a UE may transition from a DRX on duration to a DRX off duration after expiration of an inactivity timer.

As an example, when a UE is in a DRX off duration, the UE cannot receive scheduling grants or assignments, which may prevent the UE from receiving data communications on, for example, a PDSCH. Accordingly, the UE may use a timer, which is restarted each time the UE receives a PDCCH to indicate a new uplink or downlink transmission, to determine whether to remain in the DRX on duration (and continue monitoring for a PDCCH) or transition to the DRX off duration. However, in some cases, the UE may waste power resources while waiting for a timer, such as an inactivity timer, to expire. For example, when a UE receives a PDCCH, the UE may reset an inactivity timer, but may receive no further communications for a duration of the inactivity timer. In this case, the period when the UE is waiting for the inactivity timer to expire, but is not receiving further communications (or transmitting any communications) may be a period when the UE could have been in a lower power state. For example, in burst communications, a burst transmission may be shorter than an inactivity timer duration, which may result in the UE remaining in a DRX on duration for a period of time after the burst transmission has ended. A length of the inactivity timer can be reduced to save power (e.g., by allowing the UE to enter the lower power state faster), but this can result in the UE prematurely entering the lower power state (e.g., when a network entity had further control information or data to transmit to the UE).

Some aspects described herein use burst metadata to provide burst awareness. For example, a first network entity (e.g., a base station) may receive, from a second network entity (e.g., a core network entity, such as an application server (AS) or a UPF, among other examples) an end of burst indication associated with burst metadata accompanying a burst transmission of one or more packets. In this case, the first network entity may determine when the burst transmission is to end and may transmit a power control indication to trigger a transition from a first communication state (e.g., a DRX on duration) to a second communication state (e.g., a DRX off duration). Based at least in part on receiving the power control indication, a UE may transition from the first communication state to the second communication state. In this way, the UE avoids remaining in the first communication state for an excessive period of time, thereby saving power resources. Moreover, by transitioning based at least in part on receiving a power control indication, the UE avoids prematurely transitioning to the power saving state, thereby avoiding dropped communications during the DRX off duration or excessive latency associated with communications being delayed until a next DRX on duration.

FIG. 7 is a diagram illustrating an example 700 associated with power control for burst communications, in accordance with the present disclosure. As shown in FIG. 7, example 700 includes communication between a first network entity 702 (e.g., a network node 110, a CU 310, a DU 330, an RU 340, a network entity 602, or a network entity 604), a second network entity 704 (e.g., an AS, a UPF, a network entity 606, or a network entity 608), and a UE 120.

As further shown in FIG. 7, and by reference number 710, first network entity 702 may receive and provide a burst transmission to UE 120. For example, first network entity 702 may receive and transmit a traffic flow with a burst packetization structure (e.g., sets of packets forming a set of ADUs of a burst). In some aspects, one or more second network entities 704 communicate burst signaling relating to the burst transmission to enable the burst transmission and the associated end of burst indication. For example, an edge server (e.g., an AS) may communicate burst signaling to a UPF, which can include burst metadata with IP packets of the burst transmission.

As further shown in FIG. 7, and by reference numbers 720 and 730, first network entity 702 may receive, in connection with the burst transmission, an end of burst indication, and may transmit a power control indication, such as a power saving indication.

In some aspects, first network entity 702 may receive ADU information from second network entity 704, which may enable transmission of the power control indication. For example, second network entity 704 may generate a GTP-U header that includes one or more ADU awareness fields, which may comprise ADU metadata (e.g., which may comprise or be included in burst metadata). In this case, first network entity 702 may receive the GTP-U header and identify a field including an ADU-based service flow flag, an ADU sequence number in a burst, a burst sequence number, a size of an ADU, an ADU content policy, an ADU discard time, or an IP sequence number in an ADU.

In some aspects, first network entity 702 may receive burst metadata with a field to indicate a last PDU in the burst transmission. For example, the first network entity 702 may identify a burst service flow flag and/or a last PDU of the burst flag. In this case, when the last PDU of the burst flag is set to, for example, ‘0’ for an IP packet, the IP packet is not the last packet of the burst transmission. In contrast, when the last PDU of the burst flag is set to, for example, ‘1’ for the IP packet, the IP packet is the last packet of the burst transmission. In this case, the first network entity 702 may transmit a power control indication after or in connection with transmitting the last packet of the burst transmission. In this way, first network entity 702 enables power saving in scenarios where packets arrive at first network entity 702 in order, a quantity of IP packets in a burst transmission is not available at an output of an encoder (e.g., when packets are sent before full encoding, such as for low-latency applications), and/or when first network entity 702 only needs burst awareness information for power saving (e.g., and not for FEC or other functionalities).

In some aspects, the first network entity 702 may detect or predict a packet loss associated with the burst transmission and may fall back to an inactivity timer. For example, the first network entity 702 may detect that a packet has been lost as a result of a set of packet sequence numbers (e.g., the first network entity 702 may detect a missing sequence number of a set of sequence numbers). Similarly, the first network entity 702 may predict that a packet loss may occur as a result of a detected condition, such as an amount of traffic occurring in a network or a quality of a connection between first network entity 702 and second network entity 704, among other examples. In these cases, the packet loss or predicted packet loss can cause the first network entity 702 to miss burst metadata, such as an end of burst indication. Accordingly, first network entity 702 may fall back to using, for example, an inactivity timer to determine when to transmit a power control indication. In this way, the first network entity 702 avoids the UE 120 remaining in the first communication state for an excessive period of time as a result of a missed end of burst indication and a failure to transmit a power control indication.

In some aspects, first network entity 702 may receive burst metadata in, for example, a GTP-U header, with a set of fields to enable first network entity 702 to transmit the power control indication in an out-of-order packet scenario. For example, first network entity 702 may receive burst metadata that includes a burst service flow flag, a burst sequence number, an indicator of a number of IP packets in a burst or a last PDU of a burst flag, and/or an IP sequence number in a burst indicator. The burst service flow flag may indicate whether an IP packet belongs to an ADU-based service flow, in which case the first network entity 702 may interpret other elements of the burst metadata as providing information relating to the burst transmission (e.g., when the IP packet does not belong to the ADU-based service flow, the first network entity 702 may ignore other elements of the burst metadata or may interpret the other elements of the burst metadata for another purpose). The other elements of the burst metadata may include information identifying a head packet, a set of middle packets, and a last packet of the ADU. The burst sequence number may indicate a burst transmission in which an IP packet is included. The indicator of the number of IP packets in a burst may enable the first network entity 702 to count a quantity of received IP packets in the burst transmission to identify a last packet of the burst transmission. The IP sequence number in a burst indicator may identify an IP packet within a burst transmission.

The first network entity 702 may use the burst metadata to identify an end of a burst transmission even when packets are received out of order (e.g., using the indication of the quantity of IP packets in the burst to count packets and the indication of the burst sequence number and the IP sequence number to determine which packets are associated with which burst or other transmissions). Additionally, or alternatively, when packet loss occurs, the first network entity 702 may use the burst sequence number and the number of IP packets in a burst indicator (or last PDU of a burst flag) to detect the packet loss. In this case, when first network entity 702 detects packet loss, first network entity 702 may fall back to using an inactivity timer to trigger transmission of the power control indication, as described above.

In some aspects, the first network entity 702 may receive burst metadata and ADU metadata. For example, the first network entity 702 may receive a set of information elements of burst metadata and a set of information elements of ADU metadata. In this case, the first network entity 702 may interpret information elements identifying a burst service flow flag, a last ADU of the burst flag (e.g., which is set in all PDUs of a last ADU), an ADU sequence number indicator, an ADU content policy indicator (e.g., a minimum percentage of burst bits that are to be delivered when an ADU is FEC protected), an ADU discard time indicator, or a size of the ADU indicator, among other examples. In some aspects, the first network entity 702 may receive burst metadata and ADU metadata conveying all of the aforementioned information elements. By receiving the aforementioned information elements, the first network entity 702 can provide a power savings indication to the UE 120 in a scenario where packets are received in order and a quantity of ADUs in a burst is not available at an output of an encoder, as described above. Moreover, when the first network entity 702 receives the burst metadata and the ADU metadata, the ADUs may be FEC-protected, which may enable the first network entity 702 to transmit the power savings indication to transition the UE 120 to a lower power state before the last IP packet of a burst transmission is received. In this case, when a threshold percentage of IP packets have been received (e.g., with the threshold based at least in part on the ADU content policy indicator), the first network entity 702 can transmit the power savings indication, and FEC-protection of the ADU can account for any IP packets after the UE 120 enters the lower power state.

Additionally, or alternatively, the first network entity 702 may receive a set of information elements of burst metadata and ADU metadata including information elements conveying a burst service flow flag, a burst sequence number, an indicator of a number of ADUs in a burst or a last ADU of the burst flag, an ADU sequence number, an ADU content policy, an ADU discard time, or a size of an ADU, among other examples. In some aspects, the first network entity 702 may receive burst metadata and ADU metadata conveying all of the aforementioned information elements. In this way, the first network entity 702 can transmit a power savings indication when a quantity of ADUs in a burst is available at an output of an encoder and when FEC is enabled for ADUs.

As further shown in FIG. 7, and by reference number 740, UE 120 may transition from a first communication state to a second communication state based at least in part on receiving a power control indication. For example, when the UE 120 receives a power control indication (e.g., triggered by an end of burst indication that is explicitly conveyed or derived based on burst metadata and/or ADU metadata, or that is triggered based at least in part on a timer as a fallback), the UE 120 may transfer to a different (e.g., lower) power state (e.g., to reduce a consumption of power resources).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with power control for burst communications.

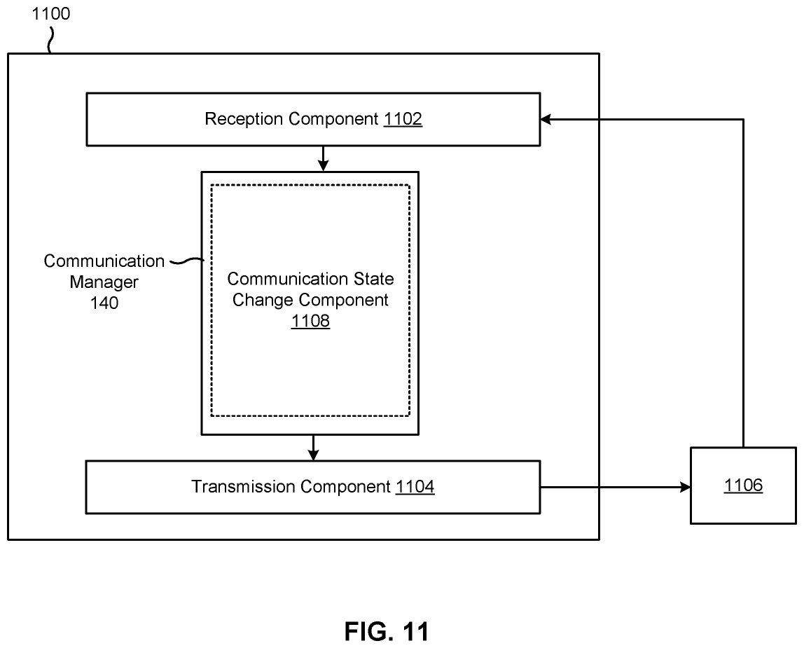

As shown in FIG. 8, in some aspects, process 800 may include receiving a burst transmission including one or more packets (block 810). For example, the UE (e.g., using communication manager 140 and/or reception component 1102, depicted in FIG. 11) may receive a burst transmission including one or more packets, as described above.

As further shown in FIG. 8, in some aspects, process 800 may include transitioning from a first communication state to a second communication state based at least in part on receiving a power control indication triggered by an end of burst indication associated with burst metadata accompanying the burst transmission, wherein a power of the second communication state is different from a power of the first communication state (block 820). For example, the UE (e.g., using communication manager 140 and/or communication state change component 1108, depicted in FIG. 11) may transition from a first communication state to a second communication state based at least in part on receiving a power control indication triggered by an end of burst indication associated with burst metadata accompanying the burst transmission, wherein a power of the second communication state is different from a power of the first communication state, as described above.

Process 800 may include additional aspects, such as any single aspect or any combination of aspects described below and/or in connection with one or more other processes described elsewhere herein.

In a first aspect, the end of burst indication comprises an indicator in a packet that indicates that the packet is a last packet of the burst transmission.

In a second aspect, alone or in combination with the first aspect, the end of burst indication is based at least in part on at least one of a burst service flow parameter, a burst sequence number parameter, an end of burst flag, a parameter identifying a quantity of packets in the burst transmission, or a parameter identifying a sequence number of the one or more packets in the burst transmission.

In a third aspect, alone or in combination with one or more of the first and second aspects, the end of burst indication is based at least in part on burst metadata included in a general packet radio service tunnelling protocol user plane header of at least one packet.

In a fourth aspect, alone or in combination with one or more of the first through third aspects, the burst metadata includes a burst service flow parameter, a burst sequence number parameter, a parameter indicating one or more last ADUs of a burst, or an ADU sequence number parameter.

In a fifth aspect, alone or in combination with one or more of the first through fourth aspects, the burst metadata includes an ADU content policy parameter, an ADU discard time parameter, or an ADU size parameter.

In a sixth aspect, alone or in combination with one or more of the first through fifth aspects, transitioning from the first communication state to the second communication state includes transitioning from the first communication state to the second communication state based at least in part on a detection of packet loss and an expiration of a timer.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., a network node 110, a CU 310, a DU 330, an RU 340, or a network entity 402/502/602/604/606/702/704, among other examples) performs operations associated with power control for burst communications.

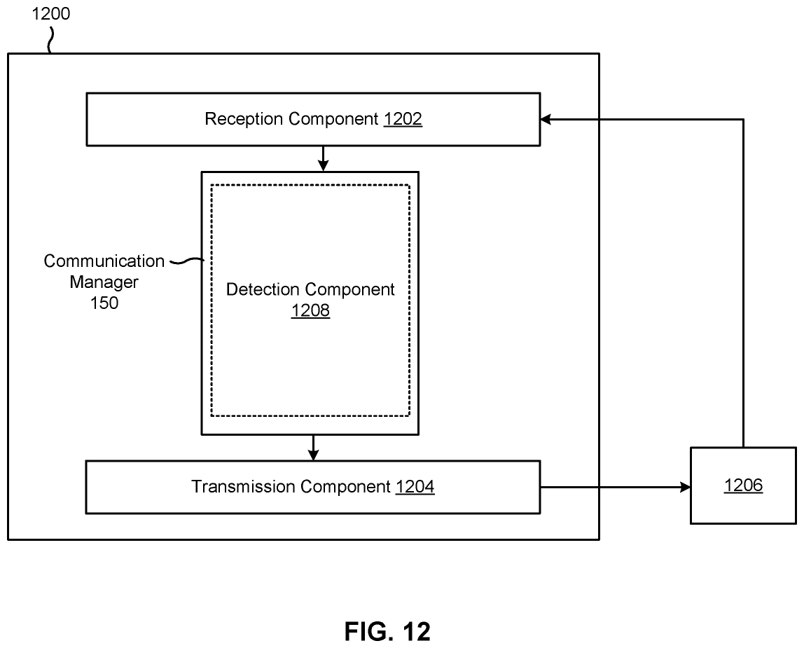

As shown in FIG. 9, in some aspects, process 900 may include receiving an end of burst indication, associated with burst metadata accompanying a burst transmission of one or more packets, identifying an end of the burst transmission of one or more packets (block 910). For example, the network entity (e.g., using communication manager 150 and/or reception component 1202, depicted in FIG. 12) may receive an end of burst indication, associated with burst metadata accompanying a burst transmission of one or more packets, identifying an end of the burst transmission of one or more packets, as described above.

As further shown in FIG. 9, in some aspects, process 900 may include transmitting a power control indication, in connection with the burst transmission of the one or more packets, to indicate a transition from a first communication state to a second communication state, wherein a power of the second communication state is different from a power of the first communication state (block 920). For example, the network entity (e.g., using communication manager 150 and/or transmission component 1204, depicted in FIG. 12) may transmit a power control indication, in connection with the burst transmission of the one or more packets, to indicate a transition from a first communication state to a second communication state, wherein a power of the second communication state is different from a power of the first communication state, as described above.

Process 900 may include additional aspects, such as any single aspect or any combination of aspects described below and/or in connection with one or more other processes described elsewhere herein.

In a first aspect, the end of the burst indication is included in the burst metadata.

In a second aspect, alone or in combination with the first aspect, the end of burst indication comprises an indicator, in a packet associated with the burst transmission, that indicates that the packet is a last packet of the burst transmission.

In a third aspect, alone or in combination with one or more of the first and second aspects, process 900 includes detecting a packet loss associated with the burst transmission, and transmitting the power control indication comprises transmitting the power control indication based at least in part on detecting the packet loss and an expiration of a timer.

In a fourth aspect, alone or in combination with one or more of the first through third aspects, the burst metadata associated with the end of burst indication includes at least one of a burst service flow parameter, a burst sequence number parameter, an end of burst flag, a parameter identifying a quantity of packets in the burst transmission, or a parameter identifying a sequence number of the one or more packets in the burst transmission.

In a fifth aspect, alone or in combination with one or more of the first through fourth aspects, the burst metadata associated with the end of burst indication is included in a general packet radio service tunnelling protocol user plane header of the one or more packets.

In a sixth aspect, alone or in combination with one or more of the first through fifth aspects, the burst metadata associated with the end of burst indication includes at least one of a burst service flow parameter, a burst sequence number parameter, a parameter indicating a last one or more ADUs of the burst transmission, or an ADU sequence number parameter.

In a seventh aspect, alone or in combination with one or more of the first through sixth aspects, the burst metadata associated with the end of burst indication includes at least one of an ADU content policy parameter, an ADU discard time parameter, or an ADU size parameter.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., a network node 110, a CU 310, a DU 330, an RU 340, or a network entity 402/502/602/604/606/702/704, among other examples) performs operations associated with power control for burst communications.

As shown in FIG. 10, in some aspects, process 1000 may include receiving application data for transmission to a UE via another network entity (block 1010). For example, the network entity (e.g., using communication manager 150 and/or reception component 1202, depicted in FIG. 12) may receive application data for transmission to a UE via another network entity, as described above.

As further shown in FIG. 10, in some aspects, process 1000 may include transmitting the application data with an end of burst indication, associated with burst metadata accompanying a burst transmission of one or more packets of the application data, identifying an end of the burst transmission of one or more packets (block 1020). For example, the network entity (e.g., using communication manager 150 and/or transmission component 1204, depicted in FIG. 12) may transmit the application data with an end of burst indication, associated with burst metadata accompanying a burst transmission of one or more packets of the application data, identifying an end of the burst transmission of one or more packets, as described above.

Process 1000 may include additional aspects, such as any single aspect or any combination of aspects described below and/or in connection with one or more other processes described elsewhere herein.

In a first aspect, the end of the burst indication is included in the burst metadata.

In a second aspect, alone or in combination with the first aspect, the end of burst indication comprises an indicator, in a packet associated with the burst transmission, that indicates that the packet is a last packet of the burst transmission.

In a third aspect, alone or in combination with one or more of the first and second aspects, the burst metadata associated with the end of burst indication includes at least one of a burst service flow parameter, a burst sequence number parameter, an end of burst flag, a parameter identifying a quantity of packets in the burst transmission, or a parameter identifying a sequence number of the one or more packets in the burst transmission.

In a fourth aspect, alone or in combination with one or more of the first through third aspects, the burst metadata associated with the end of burst indication is included in a general packet radio service tunnelling protocol user plane header of the one or more packets.

In a fifth aspect, alone or in combination with one or more of the first through fourth aspects, the burst metadata associated with the end of burst indication includes at least one of a burst service flow parameter, a burst sequence number parameter, a parameter indicating a last one or more ADUs of the burst transmission, or an ADU sequence number parameter.

In a sixth aspect, alone or in combination with one or more of the first through fifth aspects, the burst metadata associated with the end of burst indication includes at least one of an ADU content policy parameter, an ADU discard time parameter, or an ADU size parameter.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a communication state change component 1108, among other examples.

In some aspects, the apparatus 1100 may be configured to perform one or more operations described herein in connection with FIG. 7. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive a burst transmission including one or more packets. The communication state change component 1108 may transition from a first communication state to a second communication state based at least in part on receiving a power control indication triggered by an end of burst indication associated with burst metadata accompanying the burst transmission, wherein a power of the second communication state is different from a power of the first communication state.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a detection component 1208, among other examples.

In some aspects, the apparatus 1200 may be configured to perform one or more operations described herein in connection with FIG. 7. Additionally, or alternatively, the apparatus 1200 may be configured to perform one or more processes described herein, such as process 900 of FIG. 9 or process 1000 of FIG. 10, among other examples. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The reception component 1202 may receive an end of burst indication, associated with burst metadata accompanying a burst transmission of one or more packets, identifying an end of the burst transmission of one or more packets. The transmission component 1204 may transmit a power control indication, in connection with the burst transmission of the one or more packets, to indicate a transition from a first communication state to a second communication state, wherein a power of the second communication state is different from a power of the first communication state. The detection component 1208 may detect a packet loss associated with the burst transmission.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving a burst transmission including one or more packets; and transitioning from a first communication state to a second communication state based at least in part on receiving a power control indication triggered by an end of burst indication associated with burst metadata accompanying the burst transmission, wherein a power of the second communication state is different from a power of the first communication state.
Aspect 2: The method of Aspect 1, wherein the end of burst indication comprises an indicator in a packet that indicates that the packet is a last packet of the burst transmission
Aspect 3: The method of any of Aspects 1 to 2, wherein transitioning from the first communication state to the second communication state comprises: transitioning from the first communication state to the second communication state based at least in part on a detection of packet loss and an expiration of a timer.
Aspect 4: The method of any of Aspects 1 to 3, wherein the end of burst indication is based at least in part on at least one of: a burst service flow parameter, a burst sequence number parameter, an end of burst flag, a parameter identifying a quantity of packets in the burst transmission, or a parameter identifying a sequence number of the one or more packets in the burst transmission.
Aspect 5: The method of any of Aspects 1 to 4, wherein the end of burst indication is based at least in part on burst metadata included in a general packet radio service tunnelling protocol user plane header of at least one packet.
Aspect 6: The method of Aspect 5, wherein the burst metadata includes a burst service flow parameter, a burst sequence number parameter, a parameter indicating one or more last application data units (ADUs) of a burst, or an ADU sequence number parameter.
Aspect 7: The method of Aspect 5, wherein the burst metadata includes an application data unit (ADU) content policy parameter, an ADU discard time parameter, or an ADU size parameter.
Aspect 8: A method of wireless communication performed by a network entity, comprising: receiving an end of burst indication, associated with burst metadata accompanying a burst transmission of one or more packets, identifying an end of the burst transmission of one or more packets; and transmitting a power control indication, in connection with the burst transmission of the one or more packets, to indicate a transition from a first communication state to a second communication state, wherein a power of the second communication state is different from a power of the first communication state.
Aspect 9: The method of Aspect 8, wherein the end of the burst indication is included in the burst metadata.
Aspect 10: The method of any of Aspects 8 to 9, wherein the end of burst indication comprises an indicator, in a packet associated with the burst transmission, that indicates that the packet is a last packet of the burst transmission.
Aspect 11: The method of any of Aspects 8 to 10, further comprising: detecting a packet loss associated with the burst transmission; and wherein transmitting the power control indication comprises: transmitting the power control indication based at least in part on detecting the packet loss and an expiration of a timer.
Aspect 12: The method of any of Aspects 8 to 11, wherein the burst metadata associated with the end of burst indication includes at least one of: a burst service flow parameter, a burst sequence number parameter, an end of burst flag, a parameter identifying a quantity of packets in the burst transmission, or a parameter identifying a sequence number of the one or more packets in the burst transmission.
Aspect 13: The method of any of Aspects 8 to 12, wherein the burst metadata associated with the end of burst indication is included in a general packet radio service tunnelling protocol user plane header of the one or more packets.
Aspect 14: The method of any of Aspects 8 to 13, wherein the burst metadata associated with the end of burst indication includes at least one of: a burst service flow parameter, a burst sequence number parameter, a parameter indicating a last one or more application data units (ADUs) of the burst transmission, or an ADU sequence number parameter.
Aspect 15: The method of any of Aspects 8 to 14, wherein the burst metadata associated with the end of burst indication includes at least one of: an application data unit (ADU) content policy parameter, an ADU discard time parameter, or an ADU size parameter.
Aspect 16: A method of wireless communication performed by a network entity, comprising: receiving application data for transmission to a user equipment (UE) via another network entity; and transmitting the application data with an end of burst indication, associated with burst metadata accompanying a burst transmission of one or more packets of the application data, identifying an end of the burst transmission of one or more packets.
Aspect 17: The method of Aspect 16, wherein the end of the burst indication is included in the burst metadata.
Aspect 18: The method of any of Aspects 16 to 17, wherein the end of burst indication comprises an indicator, in a packet associated with the burst transmission, that indicates that the packet is a last packet of the burst transmission.
Aspect 19: The method of any of Aspects 16 to 18, wherein the burst metadata associated with the end of burst indication includes at least one of: a burst service flow parameter, a burst sequence number parameter, an end of burst flag, a parameter identifying a quantity of packets in the burst transmission, or a parameter identifying a sequence number of the one or more packets in the burst transmission.
Aspect 20: The method of any of Aspects 16 to 19, wherein the burst metadata associated with the end of burst indication is included in a general packet radio service tunnelling protocol user plane header of the one or more packets.
Aspect 21: The method of any of Aspects 16 to 20, wherein the burst metadata associated with the end of burst indication includes at least one of: a burst service flow parameter, a burst sequence number parameter, a parameter indicating a last one or more application data units (ADUs) of the burst transmission, or an ADU sequence number parameter.
Aspect 22: The method of any of Aspects 16 to 21, wherein the burst metadata associated with the end of burst indication includes at least one of: an application data unit (ADU) content policy parameter, an ADU discard time parameter, or an ADU size parameter.
Aspect 23: An apparatus for wireless communication at a device, comprising a processor; memory coupled with the processor; and instructions stored in the memory and executable by the processor to cause the apparatus to perform the method of one or more of Aspects 1-7.
Aspect 24: A device for wireless communication, comprising a memory and one or more processors coupled to the memory, the one or more processors configured to perform the method of one or more of Aspects 1-7.
Aspect 25: An apparatus for wireless communication, comprising at least one means for performing the method of one or more of Aspects 1-7.
Aspect 26: A non-transitory computer-readable medium storing code for wireless communication, the code comprising instructions executable by a processor to perform the method of one or more of Aspects 1-7.
Aspect 27: A non-transitory computer-readable medium storing a set of instructions for wireless communication, the set of instructions comprising one or more instructions that, when executed by one or more processors of a device, cause the device to perform the method of one or more of Aspects 1-7.
Aspect 28: An apparatus for wireless communication at a device, comprising a processor; memory coupled with the processor; and instructions stored in the memory and executable by the processor to cause the apparatus to perform the method of one or more of Aspects 8-15.
Aspect 29: A device for wireless communication, comprising a memory and one or more processors coupled to the memory, the one or more processors configured to perform the method of one or more of Aspects 8-15.
Aspect 30: An apparatus for wireless communication, comprising at least one means for performing the method of one or more of Aspects 8-15.
Aspect 31: A non-transitory computer-readable medium storing code for wireless communication, the code comprising instructions executable by a processor to perform the method of one or more of Aspects 8-15.
Aspect 32: A non-transitory computer-readable medium storing a set of instructions for wireless communication, the set of instructions comprising one or more instructions that, when executed by one or more processors of a device, cause the device to perform the method of one or more of Aspects 8-15.
Aspect 33: An apparatus for wireless communication at a device, comprising a processor; memory coupled with the processor; and instructions stored in the memory and executable by the processor to cause the apparatus to perform the method of one or more of Aspects 16-22.
Aspect 34: A device for wireless communication, comprising a memory and one or more processors coupled to the memory, the one or more processors configured to perform the method of one or more of Aspects 16-22.
Aspect 35: An apparatus for wireless communication, comprising at least one means for performing the method of one or more of Aspects 16-22.
Aspect 36: A non-transitory computer-readable medium storing code for wireless communication, the code comprising instructions executable by a processor to perform the method of one or more of Aspects 16-22.
Aspect 37: A non-transitory computer-readable medium storing a set of instructions for wireless communication, the set of instructions comprising one or more instructions that, when executed by one or more processors of a device, cause the device to perform the method of one or more of Aspects 16-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a burst transmission including one or more packets; and
transition from a first communication state to a second communication state based at least in part on receiving a power control indication triggered by an end of burst indication associated with burst metadata accompanying the burst transmission, wherein a power of the second communication state is different from a power of the first communication state.

2. The UE of claim 1, wherein the power control indication is a power saving indication.

3. The UE of claim 1, wherein the power of the second communication state is less than the power of the first communication state.

4. The UE of claim 1, wherein the end of burst indication comprises an indicator in a packet that indicates that the packet is a last packet of the burst transmission.

5. The UE of claim 1, wherein the one or more processors, to transition from the first communication state to the second communication state, are configured to:
transition from the first communication state to the second communication state based at least in part on a detection of packet loss and an expiration of a timer.

6. The UE of claim 1, wherein the end of burst indication is based at least in part on at least one of:
a burst service flow parameter,
a burst sequence number parameter,
an end of burst flag,
a parameter identifying a quantity of packets in the burst transmission, or
a parameter identifying a sequence number of the one or more packets in the burst transmission.

7. The UE of claim 1, wherein the end of burst indication is based at least in part on burst metadata included in a general packet radio service tunnelling protocol user plane header of at least one packet.

8. The UE of claim 7, wherein the burst metadata includes
a burst service flow parameter,
a burst sequence number parameter,
a parameter indicating one or more last application data units (ADUs) of a burst, or
an ADU sequence number parameter.

9. The UE of claim 7, wherein the burst metadata includes
an application data unit (ADU) content policy parameter,
an ADU discard time parameter, or
an ADU size parameter.

10. A network entity for wireless communication, comprising:
a memory; and
one or more processors, coupled to the memory, configured to:
receive an end of burst indication, associated with burst metadata accompanying a burst transmission of one or more packets, identifying an end of the burst transmission of one or more packets; and
transmit a power control indication, in connection with the burst transmission of the one or more packets, to indicate a transition from a first communication state to a second communication state, wherein a power of the second communication state is different from a power of the first communication state.

11. The network entity of claim 10, wherein the power control indication is a power saving indication.

12. The network entity of claim 10, wherein the power of the second communication state is less than the power of the first communication state.

13. The network entity of claim 10, wherein the end of the burst indication is included in the burst metadata.

14. The network entity of claim 10, wherein the end of burst indication comprises an indicator, in a packet associated with the burst transmission, that indicates that the packet is a last packet of the burst transmission.

15. The network entity of claim 10, wherein the one or more processors are further configured to:
detect a packet loss associated with the burst transmission; and
wherein the one or more processors, to transmit the power control indication, are configured to:
transmit the power control indication based at least in part on detecting the packet loss and an expiration of a timer.

16. The network entity of claim 10, wherein the burst metadata associated with the end of burst indication includes at least one of:
a burst service flow parameter,
a burst sequence number parameter,
an end of burst flag,
a parameter identifying a quantity of packets in the burst transmission, or
a parameter identifying a sequence number of the one or more packets in the burst transmission.

17. The network entity of claim 10, wherein the burst metadata associated with the end of burst indication is included in a general packet radio service tunnelling protocol user plane header of the one or more packets.

18. The network entity of claim 10, wherein the burst metadata associated with the end of burst indication includes at least one of:
a burst service flow parameter,
a burst sequence number parameter,
a parameter indicating a last one or more application data units (ADUs) of the burst transmission, or
an ADU sequence number parameter.

19. The network entity of claim 10, wherein the burst metadata associated with the end of burst indication includes at least one of:
an application data unit (ADU) content policy parameter,
an ADU discard time parameter, or
an ADU size parameter.

20. A network entity for wireless communication, comprising:
a memory; and
one or more processors, coupled to the memory, configured to:
receive application data for transmission to a user equipment (UE) via another network entity; and
transmit the application data with an end of burst indication, associated with burst metadata accompanying a burst transmission of one or more packets of the application data, identifying an end of the burst transmission of one or more packets.

21. The network entity of claim 20, wherein the end of the burst indication is included in the burst metadata.

22. The network entity of claim 20, wherein the end of burst indication comprises an indicator, in a packet associated with the burst transmission, that indicates that the packet is a last packet of the burst transmission.

23. The network entity of claim 20, wherein the burst metadata associated with the end of burst indication includes at least one of:
a burst service flow parameter,
a burst sequence number parameter,
an end of burst flag,
a parameter identifying a quantity of packets in the burst transmission, or
a parameter identifying a sequence number of the one or more packets in the burst transmission.

24. The network entity of claim 20, wherein the burst metadata associated with the end of burst indication is included in a general packet radio service tunnelling protocol user plane header of the one or more packets.

25. The network entity of claim 20, wherein the burst metadata associated with the end of burst indication includes at least one of:
a burst service flow parameter,
a burst sequence number parameter,
a parameter indicating a last one or more application data units (ADUs) of the burst transmission, or
an ADU sequence number parameter.

26. The network entity of claim 20, wherein the burst metadata associated with the end of burst indication includes at least one of:
an application data unit (ADU) content policy parameter,
an ADU discard time parameter, or
an ADU size parameter.

27. A method of wireless communication performed by a user equipment (UE), comprising:
receiving a burst transmission including one or more packets; and
transitioning from a first communication state to a second communication state based at least in part on receiving a power control indication triggered by an end of burst indication associated with burst metadata accompanying the burst transmission, wherein a power of the second communication state is different from a power of the first communication state.

28. The method of claim 27, wherein the end of burst indication comprises an indicator in a packet that indicates that the packet is a last packet of the burst transmission.

29. The method of claim 27, wherein transitioning from the first communication state to the second communication state comprises:
transitioning from the first communication state to the second communication state based at least in part on a detection of packet loss and an expiration of a timer.

30. The method of claim 27, wherein the end of burst indication is based at least in part on at least one of:
a burst service flow parameter,
a burst sequence number parameter,
an end of burst flag,
a parameter identifying a quantity of packets in the burst transmission, or
a parameter identifying a sequence number of the one or more packets in the burst transmission.
